(19) United States
(12) Patent Application Publication
(10) Pub. No.: US 2023/0037087 A1
(43) Pub. Date: Feb. 2, 2023

(54) MEMORY FORENSICS WITH DYNAMIC PROFILE GENERATION FOR CLOUD ENVIRONMENTS

(71) Applicant: Cado Security, Ltd., London (GB)

(72) Inventors: James C. Campbell, London (GB); Allan Carchrie, London (GB)

(73) Assignee: Cado Security, Ltd., London (GB)

(21) Appl. No.: 17/878,761

(22) Filed: Aug. 1, 2022

Related U.S. Application Data
(60) Provisional application No. 63/227,807, filed on Jul. 30, 2021.

(51) Int. Cl. G06F 21/56; G06F 21/55; G06F 12/109

(52) U.S. Cl. CPC G06F 21/566; G06F 12/109; G06F 21/554

(57) ABSTRACT

A method for creating a memory map of a memory present in a target machine is disclosed for electronically protecting computer systems. In one step, extracting operating system details and kernel details from the target machine. A memory image is generated from the operating system and the kernel details extracted from the target machine. The memory image comprises similar configuration as that of the target machine. A memory map is created from the memory image. The memory map includes a list of applications running in the memory of the target machine at a particular instance of time. The memory map is analyzed for security issues to identify the applications running at the particular instance of time.

This application claims the benefit of and is a non-provisional of co-pending US (Provisional) Application Serial No. 63/227,807 filed on Jul. 30, 2021, which is hereby expressly incorporated by reference in its entirety for all purposes.

### BACKGROUND

This disclosure relates in general to computer security and, but not by way of limitation, to memory forensics.

Memory Forensics is the process of analyzing volatile memory from a system Random Access Memory (RAM) to identify an activity on a system. It is often performed to identify actions a hacker has performed that were not recorded on a disk or in system logs. Performing memory forensics requires a map of where certain things sit in the memory so they can be identified. Creating a memory profile is normally a somewhat manual process of connecting to a target machine and running profile generation tools. Creation of the memory profile manually can overwrite evidence and impact the forensic integrity of the data.

### SUMMARY

In one embodiment, systems and methods for creating a memory map of one or more memories present in a target machine is provided. Details regarding operating system and kernel are extracted from the target machine. The extraction of the details include identifying which operating system and corresponding kernel is currently present on the target machine. Based on the analysis of the operating system and the kernel, a memory image is created. The memory image is an exact or as close as possible replica of the memory present in the target machine. The memory image comprises similar configuration as that of the memory present in the target machine. A memory map is created from the memory image. The memory map includes various details regarding the memory present in the target machine. The details include identifying applications running in the target machine at a particular instance of time. The memory map also include details regarding address and size of the applications running in the target machine. The memory map can be analyzed to identify applications running at the particular instance of time. The memory map can be analyzed to identify malicious codes/software running in the target machine. The analyses in the memory image is performed such that no changes are to be made in the target machine.

In one embodiment, the present disclosure provides a method for creating a memory map of a memory present in a target machine for electronically protecting computer systems. In one step, extracting operating system details and kernel details from the target machine. A memory image is generated from the operating system and the kernel details extracted from the target machine. The memory image comprises similar configuration as that of the target machine. A memory map is created from the memory image. The memory map includes a list of applications running in the memory of the target machine at a particular instance of time. The memory map is analyzed for security issues to identify the applications running at the particular instance of time.

In another embodiment, the present disclosure provides a cloud-based system for creating a memory map of a memory present in a target machine. The cloud-based system comprising a target machine, and a server coupled to the target machine. The server:
extracts operating system and kernel details from the target machine;
generates a memory image from the operating system and the kernel details extracted from the target machine, wherein the memory image comprises similar configuration as that of the target machine;
creates a memory map from the memory image, wherein the memory map includes a list of applications running in the memory of the target machine at a particular instance of time; and
analyzes the memory map to identify the applications running at the particular instance of time.

In yet another embodiment, the present disclosure provides a cloud-based system for creating a memory map of a memory present in a target machine, the cloud-based system comprising one or more processors and one or memories with code for:
extracting operating system and kernel details from the target machine;
generating a memory image from the operating system and the kernel details extracted from the target machine, wherein the memory image comprises similar configuration as that of the target machine;
creating a memory map from the memory image, wherein the memory map includes a list of applications running in the memory of the target machine at a particular instance of time; and
analyzing the memory map to identify the applications running at the particular instance of time.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of an embodiment of a system for generating a memory map;

FIG. 2 illustrates an embodiment of a method for analyzing the map of the memory present in a target machine;

FIG. 3 describes an embodiment of a method for generating memory profile;

FIG. 4 illustrates an embodiment of a high-level process of creating and analyzing a map of the memory present in the target machine; and

FIG. 5 illustrates an embodiment of a memory map in accordance with the present disclosure.

In the appended figures, similar components and/or features may have the same reference label. Where the reference label is used in the specification, the description is applicable to any one of the similar components having the same reference label.

### DETAILED DESCRIPTION

Below we provide preferred exemplary embodiment(s) only, and is not intended to limit the scope, applicability or configuration of the disclosure. Rather, preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

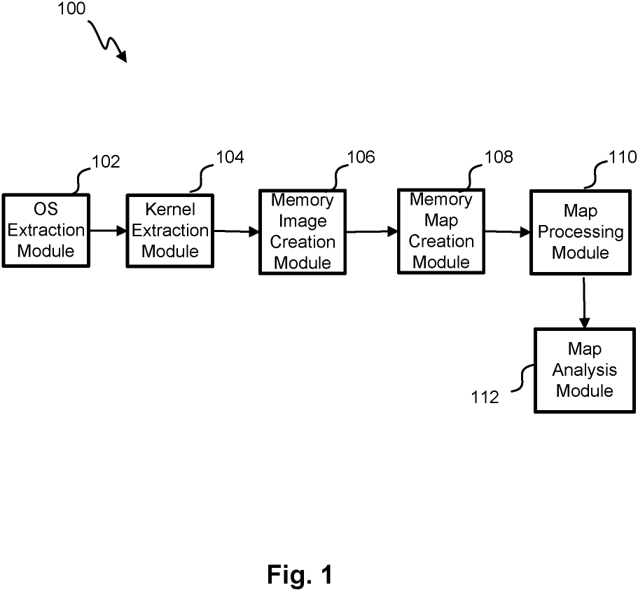

FIG. 1 illustrates a block diagram of a system 100 for generating a memory map. The system 100 comprises an Operating System (OS) extraction module 102, a kernel extraction module 104, a memory image creation module 106, a memory map creation module 108, a map processing module 110 and a map analysis module 112.

The OS extraction module 102 extracts a type of operating system running on a target machine. The target machine may include a computer, a laptop, a smart phone, etc. The type of operating system includes a Linux™ system or a Windows™ system.

The kernel extraction module 104 identifies kernel details from the target machine. Kernel is a portion of the operating system present in a memory of the target machine. The kernel extraction module 104 identifies a list of applications currently running in a memory of the target machine. The list of applications can include details of a number of applications. The details of each application can include a name of the application along with a size of the application and a number of bits required to run the application.

The memory image creation module 106 takes input from the OS extraction module 102 and the kernel extraction module 104. The memory image creation module 106 creates an image of the memory present in the target machine. The image of the memory can be a digital twin of the memory present in the target machine. The image of the memory presents a profile of the memory and is an exact copy of the memory. The profile of the memory includes all the details of the applications running in the memory. Further, the image of the memory represents identical configuration of the memory.

The image of the memory is used by the memory map creation module 108 for creating a map of the memory present in the target machine. The memory map creation module 108 indicates how memory is laid out. In other words, the memory map provides details about a layout of the memory. The map includes a list of applications running in the memory along with an address and content of the memory. The advantage of creating the memory map from the image of the memory is that there is no requirement of making changes in original memory of the target machine.

Once the map of the image is created by the memory map creation module 108, the map is processed by the map processing module 110. The processing of the map includes extracting useful information from the memory map. The information to be extracted from the map includes identifying real-time information from the map, for example, real-time applications running in the memory. The processing of the map helps the map analysis module 112 to identify important information from the map.

The map analysis module 112 provides analysis of the map. The analysis of the map helps find malicious code running in the memory. The analysis of the map also helps extract configuration information of the memory present in the target machine. The map analysis module 112 also helps identify what all processes were/are running in the memory of the target machine at a particular instance of time.

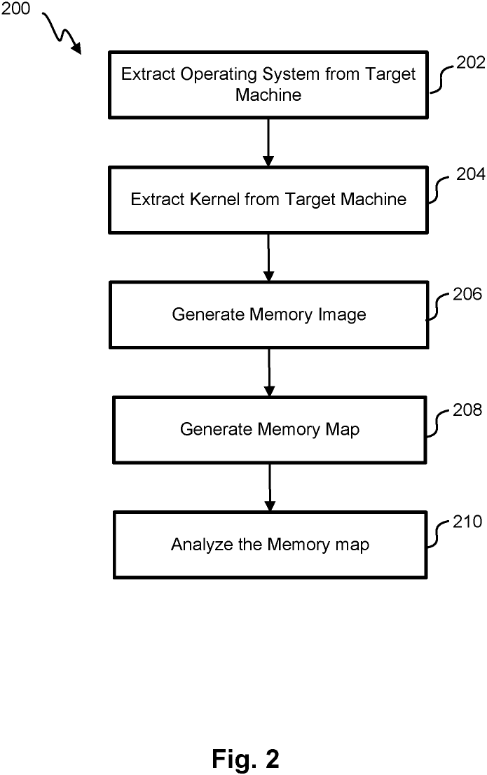

FIG. 2 illustrates a method 200 for analyzing the map of the memory present in a target machine. At blocks 202 and 204, an operating system and a kernel from the target machine are extracted, respectively. The operating system and the kernel are extracted to identify a type of the operating system that is being operated in the target machine.

At block 206, a memory image is generated from the extracted operating system and the kernel. The memory image describes the exact configuration of the memory present in the target machine. The memory image describes the details about the applications running in the memory in the target machine. The details about the applications include the applications that are currently running in the memory along with a size and an address of the applications in the memory.

At block 208, the memory map is created from the memory image. The creation of the memory map from the memory image instead of the memory of the target machine provides advantage that there is no requirement of running anything on the target machine? that would damage its forensic integrity.

At block 210, an analysis of the memory map is performed. The analysis of the memory map helps analyze different types of information, for example, identifying if there is any malicious code/software running in the memory, or identifying applications running in the memory at a given instance of time.

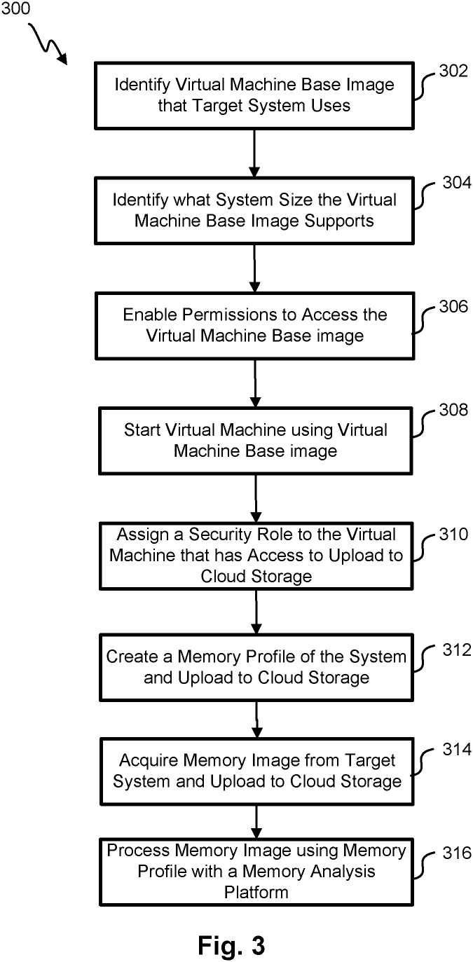

FIG. 3 describes a method 300 for generating memory profile. The method 300 begins at block 302 where a donor virtual machine base image is identified which is then used to identify a target machine. The donor virtual machine base image is an exact replica of the target machine. The donor virtual machine base image shows same applications running on the target image. At block 304, a size of the target machine which the donor virtual machine base image supports is identified. The size of the donor virtual machine base image will be the same as that of the target machine. At block 306, a permission is obtained or enabled to access the donor virtual machine base image. This step can be optional. In other words, the permission may be enabled by default and enabling the permissions to access the donor virtual machine base image may not be required.

At block 308, a virtual machine is started using a donor virtual machine base image. This includes providing for the virtual machine similar to the target machine. Similar virtual machine will have similar configurations and will run same applications as that present in the target machine.

At block 310, a security role is assigned to the virtual machine so that the virtual machine can upload to a cloud storage. The virtual machine is in communication with the cloud storage. The cloud storage stores a memory profile of the target machine. The memory profile contains details about the memory. The memory profile contains details regarding a size of the memory, an address of the memory, applications present in the memory, sizes of the applications, and/or address acquired by the applications, etc. Thus, at block 312, a memory profile of the target machine is created and uploaded to the cloud storage.

At block 314, the memory image from the target machine is acquired and uploaded to the cloud storage. The memory image contains identical configurations of the memory present in the target machine. The memory image further contains details about applications currently present in the memory. At block 316, the memory image is processed using the memory profile with a memory analysis platform. The processing includes identifying malicious codes/applications present in the memory, identifying the applications running in the memory at a particular instance of time, etc.

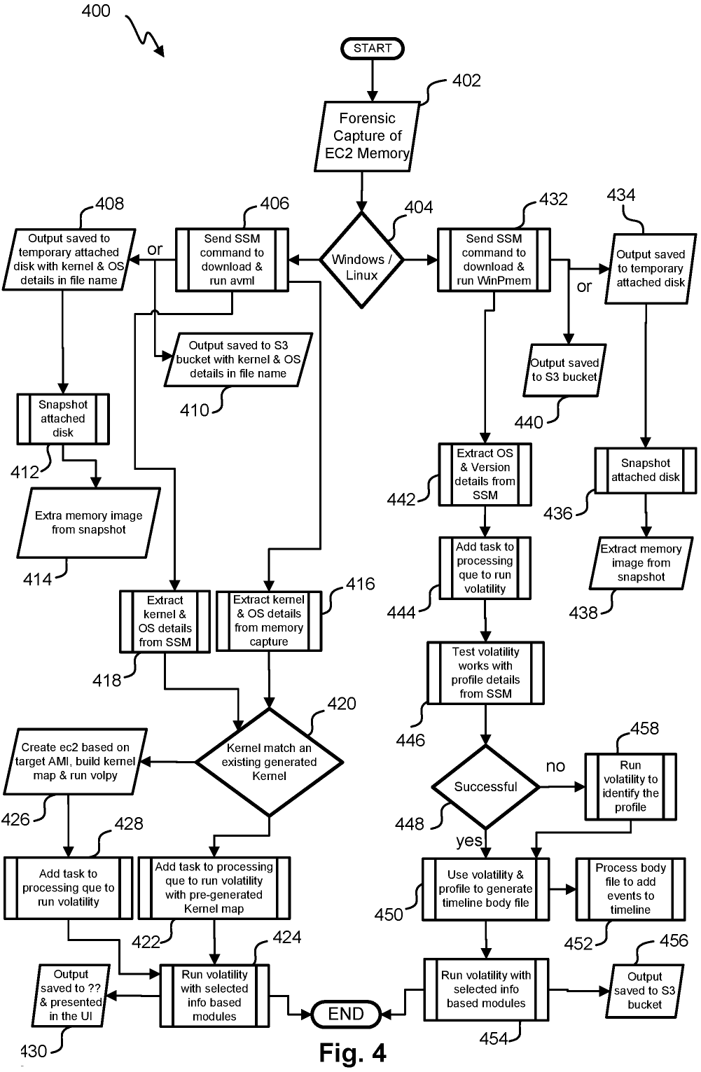

FIG. 4 illustrates a high-level process 400 of creating and analyzing a map of the memory present in the target machine. The process 400 begins at block 402, where a forensic capture of the memory present on the target machine starts. Then it is determined, at block 404, which operating system is currently running on the target machine. The operating system includes Windows™ or Linux™. The method proceeds to block 406 if the operating system is Linux™ based and proceeds to block 432, if the operating system is Windows™ based.

If the operating system is Linux™ based, at block 406, a System Manager Agent (SSM) command is sent to download and run Acquire Volatile Memory for Linux (AVML). The SSM command helps to identify various details regarding the operating system and the kernel running in the target machine. Once the operating system and the kernel are identified the output is saved to a temporary attached disk with kernel and OS details under a file name, at block 408. Alternatively, at block 410, the details regarding the operating system and the kernel are saved in S3 bucket under a file name. The S3 bucket is a cloud-based storage services provided by a service provider. Once details are saved under the file name, at block 412, a snapshot of the memory present in the target machine is created. The snapshot comprises an exact configuration of the memory as that present in the target machine. From the snapshot thus created, a memory image is extracted from the snapshot, at block 414. The memory image can be analyzed to identify malicious software present in the memory, the applications running in the memory, etc.

In one embodiment, from block 406, the method 400 proceeds to block 416, where the kernel and the operating system details are extracted from a memory capture. The memory capture can include a memory image or a digital twin of the memory present in the target machine. In another embodiment, from block 406, the method 400 proceeds to block 418 where kernel and operating system details are extracted from the SSM. The method 400 from block 416 or 418 proceeds to block 420, where it is checked whether the kernel match with an existing generated kernel. In other words, the kernel details extracted from the memory image are matched with the kernel details already existing. If the kernel details match with an existing generated kernel, the method 400 proceeds to block 422, where a task is added to processing queue to run volatility with pre-generated kernel map. At block 424, the volatility is run with selected information-based modules. The output from block 424 is saved and presented in a user interface at block 426. The output can include memory map which provide details regarding the list of applications running in the memory and the malicious software present in the memory of the target machine.

At block 426, an elastic compute ec2 is created based on a target Amazon Machine Image (AMI) and a kernel map is built and volatility tool is run. The volatility tool helps analyze the applications running in the memory. From block 426, the method 400 proceeds to block 428 where a task is added to processing queue to run volatility from where the method 400 proceeds to 424.

At block 404 when it is determined that the operating system is Windows™ based, the method 400 proceeds to block 432. At block 432, the SSM command is sent to download and a WinPmem is run. The WinPmem is a physical memory acquisition tool which acquires configuration and other details of the memory present in the target machine. This tool works as a memory analysis tool. Further processes from blocks 434-444 are similar to the one which were explained when the operating system was Linux™ based and hence have been omitted for the sake of redundancy. After block 444, the method 400 proceeds to block 446, where it is determined if test volatility works with profile details from SSM. If test volatility works with profile details from SSM (YES at block 448), volatility and profile are used to generate a timeline body file, at block 450. The timeline body file can list down a number of applications running in the memory of the target machine along with the timeline of the applications. The timeline defines the time instance at which the applications run in the memory of the target machine. At block 452, the body file is processed to add events to timeline. The addition of events denotes addition of new applications in the memory. Rest of the processes remain same as performed when the operating system is Linux™ based and hence have been omitted here. However, if at block 448, if test volatility does not work with profile details from SSM, the method 400 proceeds to block 458 where volatility is run to identify a memory profile. The memory profile comprises details regarding the applications running in the memory. The memory profile represents similar configuration as that of the memory present in the target machine.

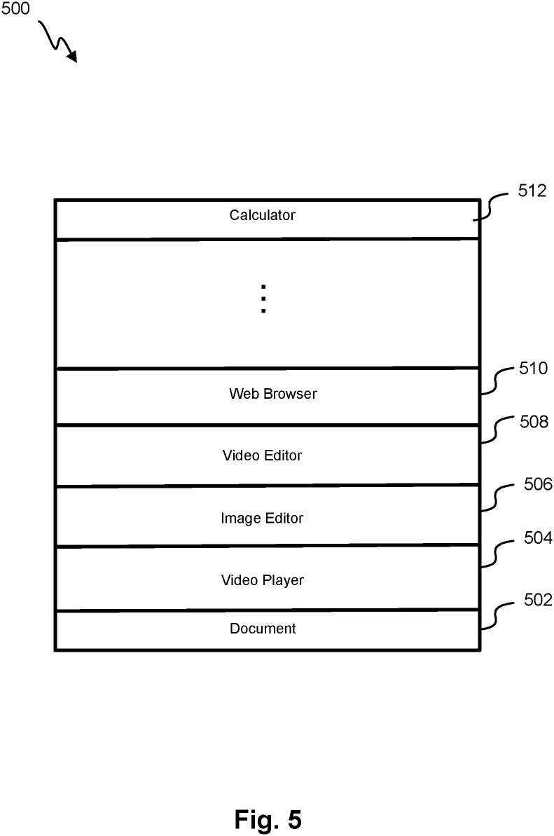

FIG. 5 illustrates an exemplary embodiment of a memory map 500 in accordance with some embodiment of the present disclosure. The memory map 500 shows a list of applications running in the memory of the target machine. The list of applications presents in the memory map 500 includes applications, like applications for opening a document 502, playing a video 504, editing an image 506, editing a video 508, browsing web 510, a calculator 512. The list of applications is not limited to one mentioned here and may include any application.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electromechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art. While the principles of the disclosure have been described above in connection with specific apparatuses and methods, it is to be clearly understood that this description is made only by way of example and not as limitation on the scope of the disclosure.

What is claimed is:

1. A cloud-based system for creating a memory map of a memory present in a target machine, the cloud-based system comprising
a target machine, and
a server coupled to the target machine, wherein the server:
extracts operating system and kernel details from the target machine;
generates a memory image from the operating system and the kernel details extracted from the target machine, wherein the memory image comprises similar configuration as that of the target machine;
creates a memory map from the memory image, wherein the memory map includes a list of applications running in the memory of the target machine at a particular instance of time; and
analyzes the memory map to identify the applications running at the particular instance of time.

2. The cloud-based system for creating the memory map of the memory present in the target machine of claim 1, wherein the memory map includes an address and a size of the applications currently running in the memory of the target machine.

3. The cloud-based system for creating the memory map of the memory present in the target machine of claim 1, wherein analyzing the memory map comprises identifying malicious software running in the memory of the target machine.

4. The cloud-based system for creating the memory map of the memory present in the target machine of claim 1, wherein the kernel details include a version of the operating system.

5. The cloud-based system for creating the memory map of the memory present in the target machine of claim 1, wherein analyzing the memory map comprises identifying a configuration of the memory of the target machine.

6. The cloud-based system for creating the memory map of the memory present in the target machine of claim 1, wherein the creating the memory map is done in the cloud geographically remote to the target machine.

7. A cloud-based system for creating a memory map of a memory present in a target machine, the cloud-based system comprising one or more processors and one or memories with code for:
extracting operating system and kernel details from the target machine;
generating a memory image from the operating system and the kernel details extracted from the target machine, wherein the memory image comprises similar configuration as that of the target machine;
creating a memory map from the memory image, wherein the memory map includes a list of applications running in the memory of the target machine at a particular instance of time; and
analyzing the memory map to identify the applications running at the particular instance of time.

8. The cloud-based system for creating the memory map of the memory present in the target machine in claim 7, wherein the memory map includes an address and a size of the applications currently running in the memory of the target machine.

9. The cloud-based system for creating the memory map of the memory present in the target machine in claim 7, wherein analyzing the memory map comprises identifying malicious software running in the memory of the target machine.

10. The cloud-based system for creating the memory map of the memory present in the target machine in claim 7, wherein the kernel details include a version of the operating system.

11. The cloud-based system for creating the memory map of the memory present in the target machine in claim 7, wherein the creating the memory map is done in the cloud geographically remote to the target machine.

12. The cloud-based system for creating the memory map of the memory present in the target machine in claim 7, wherein analyzing the memory map comprises identifying a configuration of the memory of the target machine.

13. A method for creating a memory map of a memory present in a target machine, the method comprising:
extracting operating system and kernel details from the target machine;
generating a memory image from the operating system and the kernel details extracted from the target machine, wherein the memory image comprises similar configuration as that of the target machine;
creating a memory map from the memory image, wherein the memory map includes a list of applications running in the memory of the target machine at a particular instance of time; and
analyzing the memory map to identify the applications running at the particular instance of time.

14. The method for creating the memory map, as recited in claim 13, wherein the memory map includes an address and a size of the applications currently running in the memory of the target machine.

15. The method for creating the memory map, as recited in claim 13, wherein analyzing the memory map comprises identifying malicious software running in the memory of the target machine.

16. The method for creating the memory map, as recited in claim 13, wherein the kernel details include a version of the operating system.

17. The method for creating the memory map, as recited in claim 13, wherein analyzing the memory map comprises identifying a configuration of the memory of the target machine.

18. The method for creating the memory map, as recited in claim 13, wherein the creating the memory map is done in the cloud geographically remote to the target machine.
